(19) United States
(12) Patent Application Publication
(10) Pub. No.: US 2020/0060924 A1
(43) Pub. Date: Feb. 27, 2020

(54) HANDHELD MASSAGE TOOL AND METHOD OF USING THE SAME

(71) Applicant: James Gordon Thornburg, Bend, OR (US)

(72) Inventor: James Gordon Thornburg, Bend, OR (US)

(21) Appl. No.: 16/550,082

(22) Filed: Aug. 23, 2019

Related U.S. Application Data
(60) Provisional application No. 62/722,111, filed on Aug. 23, 2018.

(51) Int. Cl. A61H 7/00

(52) U.S. Cl. CPC A61H 7/005; A61H 2201/0153

(57) ABSTRACT

A physical therapy tool comprising a handle portion formed of four edges creating a generally rectangular shape such that a first and second edges are longer and a third and fourth edges are shorter than the first and second edges and wherein at least one of the third and fourth edges is beveled. A shaft portion having two distal ends, the first distal end coupled to the handle portion. A head portion, the head portion coupled to the second distal end of the shaft portion and circular in shape wherein the side of the head portion opposite the side coupled to the shaft portion is convex.

### PRIORITY CLAIM

This application claims priority to U.S. Provisional Patent Application Ser. No. 62/722,111, filed Aug. 23, 2018, the entirety of which is hereby incorporated by references as if fully stated herein.

### FIELD OF THE INVENTION

This invention relates generally to chiropractic care, physical therapy, massage therapy, and self-massage and, more specifically, to a device and method of use for application of force to soft tissue.

### BACKGROUND OF THE INVENTION

Many athletes, as well as other recipients of bodywork, desire to feel deep/hard/heavy pressure continuously throughout the treatment. Typically, a therapist will use their hands to perform these deep pressure type treatments. In addition to using hands, there are a number of different types of handheld massage or therapy tools available to perform some types of treatments, especially dragging and scraping type treatments with metal tools as well as tempering and pressure type treatments with heavy tools. For dragging and scraping Instrument Assisted Soft Tissue Mobilization (“IASTM”) type therapy, a large number of tools are required. While for tempering and pressure based massage, the tools are large and cumbersome. The present invention offers a small all-in-one type tool which can offer multiple types of treatments without the shortcomings of the prior art.

The present invention provides a single instrument which offers the desired mechanical advantage for the therapist while also: (1) providing increased comfort for the therapist's hands, (2) providing multiple uses in a single tool including pressure and tampering style techniques, as well as IASTM dragging and scraping, (3) being small in size and low in weight, allowing the therapist to transport the tool easily, (4) optionally providing large amounts of pressure, and (5) being easy to manufacture and relatively low cost.

The present invention creates a better, novel multi-use tool combining IASTM with pressure and tempering style techniques.

### SUMMARY OF THE INVENTION

The present invention provides a tool through which a therapist can apply force to the soft tissues and muscles of their own or another person's body. The tool can be used in many different ways with varying amounts of pressure or movement across the skin to alleviate tight and painful areas of the body. The present invention overcomes limitations in the prior art by being easily transportable and usable when compared to any other prior art device designed to apply large amounts of pressure.

The present invention is a new tool in the world of handheld massage and soft tissue tools. Various embodiments of this tool may be useful in for example, but not limited to: massage therapy, physical therapy, hand therapy, chiropractic care, or to any bodywork or healthcare practitioner k in these fields. In addition to these more traditional use cases, others are of course possible. For example, additional sub-professions that may find the present invention beneficial include: massage for the elderly and geriatric people in hospitals, hospice facilities, retirement housing, senior care, etc. Additional examples include using the present invention on animals, for example, primates, canines, felines, equines, etc. Specialists can perform “bodywork” using the present invention, which is ideal to be used in these and other fields.

In various preferred embodiments, the present invention is small enough to fit in the hand of a user. In that way, the present invention is diverse from larger “tempering” devices that can weigh as much as 150 lbs and as little as 20 lbs but still quite heavy for common use. Those prior art devices are often times meant to replace the pressure that another person can apply to the body. With the present invention, the therapist user can spare his or her body some of the pressure and wear and tear put into the therapist's own body by working on the other person.

While preferred embodiments of the present invention are small, the present invention can be loaded in several different ways. For example, the present invention may be loaded with the weight of the user handling it or loaded with weight to assimilate the heavier feeling of the “tempering” effect. Additionally the present invention can be loaded with the use of a strap the wraps around the trunk or limb of a person and tightened on top of the present invention to add more direct pressure through the head piece or handle, whatever the patient prefers.

The handle side of the present invention can also be used for pressure and massage. In various embodiments of the present invention, the end of one side of the tool can have a beveled edge to allow the user to “scrape” areas of the body in a similar way to IASTM techniques and tools. The use of a tool to either scrape, smash or squish a muscle is not new, but the present invention combines all of these manual techniques into a novel handheld device that can fit in a user's coat pocket.

The present invention is novel and unique for a number of reasons. For example, the user is able to apply light to heavy pressure with a single hand, allowing his or her free hand to continue manipulating or massaging the tissue. The user is able to perform “scraping” or essentially tool based massage with the angled or beveled edges to provide a greater sensory stimulus to a smaller localized area of the body. The number of uses this tool can provide are endless. Any therapy that can be done by a fixed hand can be accomplished and practiced by use of the present invention. Currently, using prior art techniques, if a therapist wants to combine different tool-based techniques they would need to use two or more separate implements. With the present invention, any combination of treatments can be administered with this single tool. Besides the advantages of being able to perform multiple techniques with a single tool, it is also less taxing to use in the hand when compared to other prior art IASTM tools that are more flat in design and therefore compromise the hand or wrist of the person holding the tool.

For example, the shape of the present invention is deliberate in the way that it fits the hand ergonomically and provides relief to the therapist's joints, helping the user to prolong the life of their practice.

The present invention can be used with a balm (or emollient or lotion, etc.). The present invention, however, does solve another problem which is how to perform massage or other types of body work on a patient or client and be able to maintain modesty. A deliberate feature according to various embodiments of the present invention, is the finish of the metal used, which is, according to this example, stainless steel. The feel of the present invention is smooth after the polishing stage of the manufacturing process. The polished finish is meant to be able to touch the skin directly and not scratch it from commercial use, but it can also be used without a balm, etc. For example, using the above-described embodiment, the present invention can easily be used over most fabrics and therefore clothing to allow a person to remain clothed and still receive the same types of treatment and level of service that is sometimes only achieved by removing outer clothing.

In accordance with still further examples of the invention, the present invention is designed to apply large amounts of pressure to a patient. The pressure is applied by a therapist using one hand.

In accordance with yet other examples of the invention, the tool is cubical in design as opposed to a flatter design found in the prior art.

These and other examples of the invention will be described in further detail below.

### BRIEF DESCRIPTION OF THE DRAWINGS

Preferred and alternative examples of the present invention are described in detail below with reference to the following drawings:

FIGS. 1A-1D depict portions of a tool according to an embodiment of the present invention;

FIG. 2 depicts a handle portion of a tool according to an embodiment of the present invention.

FIGS. 3A-B is a head of a tool according to an embodiment of the present invention;

FIG. 4 is a shaft of a tool according to an embodiment of the present invention;

FIGS. 5A-D depict different views of a complete tool according to an embodiment of the present invention;

FIG. 6 depicts a complete tool according to an embodiment of the present invention;

### DETAILED DESCRIPTION

The present invention can come in many different sizes to accommodate different users, but preferably remains compact.

According to various embodiments of the present invention, the tool can be made out of, for example stainless steel. In other embodiments, the tool may be made out of other materials, for example, glass, polymers and various plastics, other metals, such as aluminum, as well as natural products such as wood. Special finishes or coatings may be applied where appropriate. For example, a coating may be applied to achieve a desired smooth finish which does not catch on a user's skin. Coatings may also lower friction. Materials may be selected for the same reason, for example, stainless steel may be polished to achieve desired interaction with the user's skin.

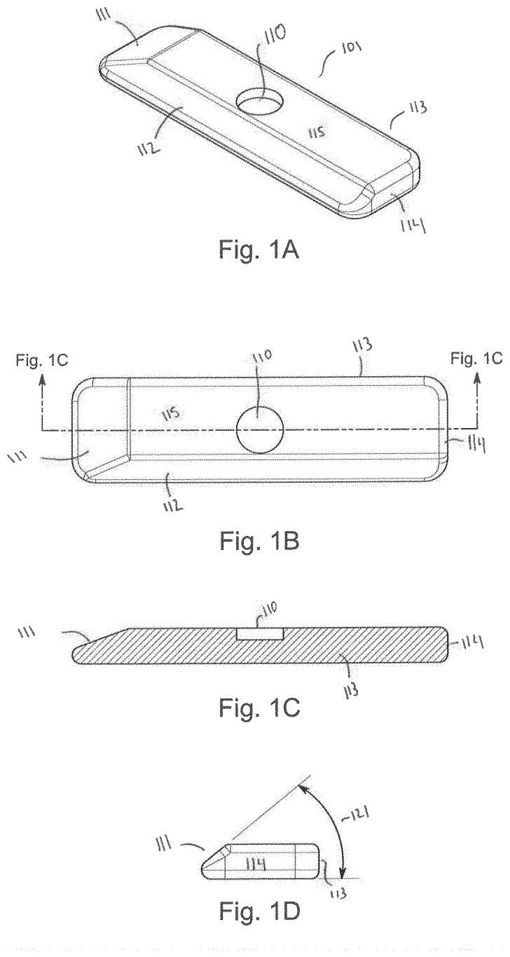

FIGS. 1A-D depict an example of a handle 101 according to an embodiment of the present invention. The handle 101 of the present invention is grasped by the therapist user. Alternatively, the handle 101 may be used against the patient, in various embodiments, as a means of transferring pressure. As depicted, the handle 101 comprises a generally rectangular shape with two longer sides, 112 and 113 as well as two shorter sides 111 and 114. Multiple sides of the rectangular shape comprise a chamfered, angled, and/or beveled edge. For example, the depicted embodiment includes two heavily beveled edges 111 and 112. The smaller heavily chamfered edge 111 may be a constant profile, or may have a profile that changes along its length. Further, the angle of the bevel relative to the top 115 may differ depending on the embodiment. As depicted, the larger heavily beveled edge 112 has an angled portion and a radius profile along its length. In alternative embodiments, a different radius or angle relative to the top 115 may be used, or, the edge may be straight. Additionally, in some embodiments, the smaller edge 111 may include a radius either in exchange of the long edge, or in addition to the long edge. In alternative embodiments, the profiles of the edge may be unique to each edge of the rectangle, or alternatively, additional edges may be heavily chamfered. As depicted, the radius of side 112 continues through small side 114. Further, according to the depicted embodiment, long side 113 does not have an angle or bevel beyond rounded edges.

Embodiments of a handle 101 according to the present invention also include a mounting hole 110. The mounting hole 110 accepts the shaft portion, described below. In various embodiments, the mounting hole 110 may not actually form a hole or impression in the upper surface 115 of the handle 101. Instead, in those embodiments, the mounting hole 110 is figuratively located where the shaft is to be located, but no impression or locating hole 110 is present. Where the mounting hole 110 is present, the depth and size will vary depending on the use case. For example, where the shaft portion is to be bonded, the hole 110 may be deeper than where, for example, the shaft portion will be welded. In other examples, the hole 110 may include threads, barbs, or other means for keeping the shaft securely located to the handle 110.

As depicted, preferably all of the edges 111-114 of the handle 110, are rounded in order to provide increased ergonomics to the user. Additionally, if the user desires to use the handle 110 against the patient, rounded corners increase comfort for the patient and prevent snagging. The angles, dimensions, and profiles depicted only represent a single possible embodiment. For example, the handle 101 is depicted with long sides 113 and 112 being about 4 inches long. In alternative embodiments the handle may be much smaller or much larger, 2 to 8 inches, for example. The same is true for the thickness and edge profiles. While larger and smaller versions may scale according to the depicted example, it is also contemplated that the types of edge profiles, location of the profiles, and such may change depending on the use case and or size.

In various embodiments, and as depicted in FIG. 1B, the hole 110 may be centrally located on the handle 101. This attachment point 110 preferably accepts a portion of the shaft. The method of attachment may vary and should not be limiting. For example, some embodiments may include male and female threads on the shaft and handle respectively. In other examples, the female threaded portion, or male threaded portion, may extend from the handle, as opposed to being recessed. In alternative embodiments, the shaft may extend into the handle, and the two may be welded or otherwise bonded together. In further examples, the two may simply be press fit together. Various embodiments are anticipated such that the handle 101 can be easily removed. This may be useful should a therapist user desire to, for example, change the type of handle 101 used, or the length of the shaft.

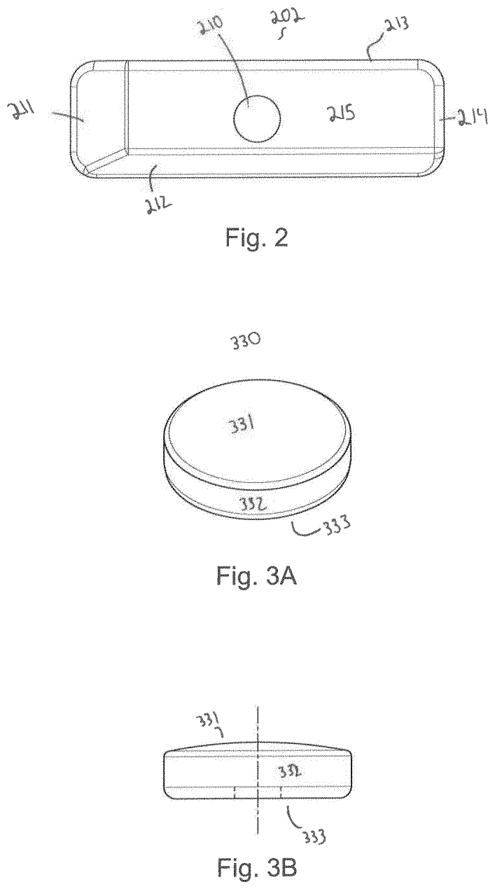

Referring now to FIG. 2, FIGS. 1A and 2 differ, for example, in that FIG. 1A depicts a narrower embodiment. This can be seen by comparing the location of the mounting hole 110 which accepts the shaft portion. This is one simple example of the types of changes possible while conforming to the teachings of the present invention.

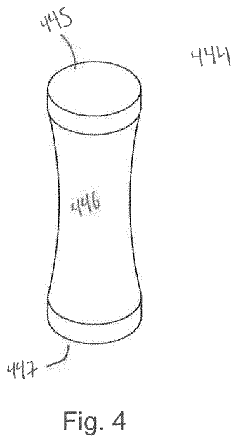

FIGS. 3A and 3B depicts an example of a head 330 of a tool according to an embodiment of the present invention. The head 330 is preferably opposite the handle 101, the head 330 and the handle 101 separated by a shaft portion. As depicted, the head 330 is preferably round. In alternative embodiments, the head 330 may be alternatively shaped, for example, a rounded square or rectangle, or other multi-sided polygons such as a hexagonal or octagonal shape. The head 330 may have soft edges, in order to provide increased comfort to the user. The size of the head 330 may be different, for example, the side 331 facing or in contact with the patient may be slightly domed, whereas the side that engages the shaft portion 333 may be flat. The side of the head 330, between the patient facing portion 331 and shaft facing portion may be generally flat in profile. The thickness of side 332 will depend on the height of the head 330. In alternative embodiments, the side 332 may not be flat, and may be angled.

In various alternative embodiments, the size of the two sides 331 and 333 may be the same, or different. For example, both sides 331 and 333 may be domed, with one side more domed than the other, in such an example, the therapist user may be able to flip the head 330 in order to change the shape of the side facing the patient, without having to resort to a completely different piece. In such an embodiment, the attachment point at the center may include a plug such that the exposed attachment point can be hidden and not interfere with the patient. In other embodiments, such as the one depicted in FIG. 3B, the upper side 331 may be domed, and the lower side 333 may be flat. FIG. 3B also depicts, with dotted lines, the center and alignment location for attachment of the shaft portion.

The angles, dimensions, and profiles depicted as exact values only represent a single possible embodiment. For example, the head 330 may have alternative diameters that are larger or smaller, for example, 1 to 6 inches. Additionally, the head 330 may be made thicker or thinner. Further still, different shapes and contours altogether may be used.

When in use, the head 330 is preferably used against the patient. As the therapist user presses on the tool with one hand, the head 330 in turn, presses against an area of the patient. Alternatively, the head 330 may held by the therapist, as a handle, and the handle portion 101, may be used against the patient, as a head, depending on the needs of the patient.

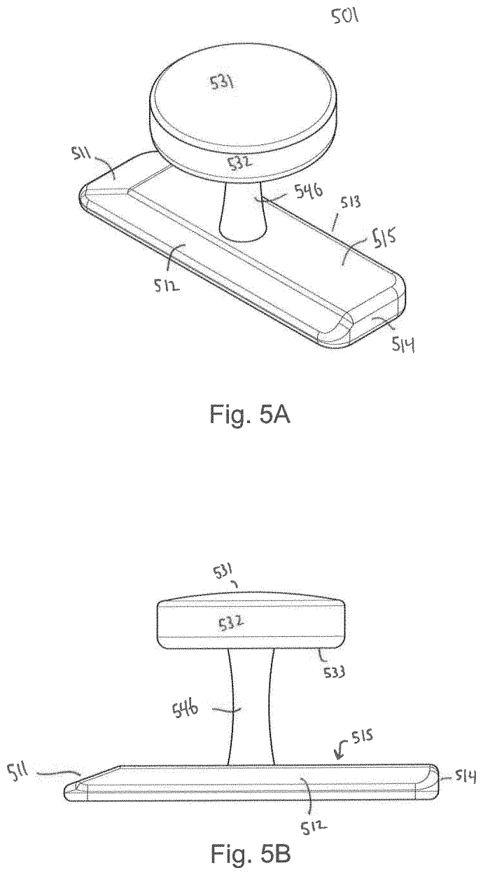

FIG. 4 depicts an example of a shaft portion 444 of a tool according to an embodiment of the present invention. In a preferred embodiment of the present invention, the shaft 444 connects the handle portion to the head portion such that force applied through either is transferred to the other. In additional embodiments, the shaft may be grasped by the therapist user in order to apply force to the patient, or, grasped where the invention is used on its side.

As depicted in FIG. 4, the shaft 444 may include a taper along its length 446. In alternative embodiments, the shaft 444 may be a constant diameter along its length. In further examples, the shaft 444 may include alternative ergonomic features, such as reliefs to accommodate a therapist user's fingers. The two distal ends of the shaft preferably attached to the head 445 and the handle 447 respectively. In order to accomplish this, the shaft 444 may include appropriate hardware, such as male or female threads, or press fit portion, or a weldable or otherwise fixable portion.

The size and length of the shaft 444 portion may change depending on the requirements of the embodiment of the invention. The angles, dimensions, and profiles only represent a single possible embodiment. For example, the length may have alternative values that are larger or smaller, for example, 0.5 to 6 inches. Additionally, the diameter may be made thicker or thinner.

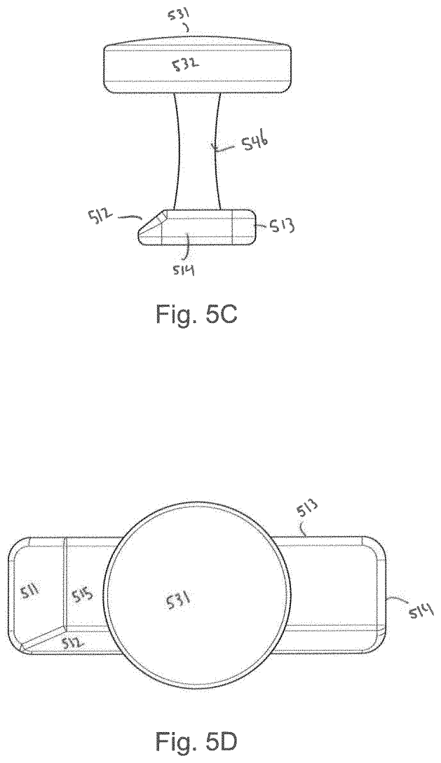

FIGS. 5A-D depicts an example of a complete tool 551 according to an embodiment of the present invention. The complete tool 551 may be made up of, for example, the embodiments and alternatives shown and described in FIGS. 1-4. The depicted embodiment of the present invention may be formed from one piece, for example through casting, forging, milling, 3D printing, injection molding, hydro-forming or the like. In other embodiments, the tool 551 may be made up of more than one piece, where the pieces are held together with attachment means such as friction, or a fastener, such as a screw or bolts, or, alternatively, the pieces may be welded or otherwise bonded together during manufacture. According to some embodiments, sections of the tool 551 may be replaceable or interchangeable. For example, a portion of the tool 551 may be removed, and replaced with a slightly different sized, weighted, or shaped portion. In addition, the various pieces may be made of different materials depending on their use. For example, the handle 501 may be made of plastic, while the shaft 544 and head 530 are made from stainless steel. Additionally, the various depicted embodiments of the present invention can be constructed from metal, or alternative materials such as wood, polymers, rubber, etc.

FIG. 5A depicts a complete tool 551 according to an embodiment of the present invention. As depicted, the handle 501 is narrower than the head portion 530. Additionally, the shaft includes a slight taper along its length 546. The portions of the tool 551 are optionally very smooth. This level of smoothness may be achieved through the manufacturing process, or alternatively, by machining or polishing after completion of the various components, or the assembly of the tool 551.

FIG. 5B depicts a side view of an embodiment of a complete tool. Here the long angled, beveled, and/or chamfered edge 512 is depicted, as is the shorter angled edge 511. As depicted, the length of shaft 546 is relatively centered within the handle portion 501. In alternative embodiments, the location of the connection between the shaft 544 and the handle 501 may change such that the handle 501 is relatively closer or further from the angled edge 511. As discussed above with respect to FIGS. 1-4, the angles, size, and other dimensions of the various components may change as required or preferred.

In one embodiment of the present invention consistent with the embodiment depicted, the invention comprises a 4×1 inch handle 501 that has a 22-degree bevel on the underside of the handle 501. The head 530 is a 2-inch diameter disc with a ⅛-inch routed edge along both 531 and 533. Both pieces are ⅜-inch thick and joined by a 2-inch long ⅜-inch diameter shaft portion 544 sealed with lock tight. In various embodiments, including the one discussed here, the invention can be finished with a high polish to allow the user to make a slippery and sliding surface by applying an emollient directly to the skin of the patient, or the head and handle piece will easily slide and glide over the surface of most clothing and specific materials designed for the use of this tool.

In some embodiments, the present invention allows for a method of use where the handle 501 is in the therapist's hand, and the head 530 of the tool is against the patient. This technique is used for applying direct pressure in range that is preferred by the client. With or without movement across the body.

In some embodiments, the present invention allows for a method of use where the head 530 of the tool is located in the therapist's hand and handle 501 against patient. This technique is used for applying direct pressure with either the wide 512 or 513 or narrow, 511 or 514, sides of the handle 501. This would allow for more of a scraping feeling and more superficial related to the body and pressure in range that is preferred by the client. With or without movement across the body.

In some embodiments, the present invention allows for a method of use where the tool 551 is “loaded” in order to increase its perceived weight. For example, the tool 551 can be loaded with any type of weight, most often it will be best to place weight onto the flat handle 501 with the round head piece 530 against the body. The amount of pressure applied is subjective to the person it is being used on. Another method to load additional pressure onto the tool 551 is with a resistance band or a stiff strap. Various embodiments of the present invention may also be heated or cooled. For example, the shaft may house a battery, which powers a heating element in the head or base.

FIG. 5C depicts an embodiment of the present invention facing the more flat narrow portion of the handle 514. As shown, the head 530 is wider than the handle 501. In other embodiments, this may not be the case. Additionally, the head 530, as shown in both FIGS. 5C and 5D, is slightly domed on top 531 and flat bottom 533. In alternatives, a domed shape, either concave or convex in nature, may be used, or both sides may be flat or domed. The relative position of the components may also change. For example, one may choose to switch out the depicted head 530 for a smaller one, or, alternatively, the depicted shaft 544 for one with ridges to ergonomically accommodate a user's fingers.

The finished embodiment 551 according to the present invention may have various surface textures. For example, the handle 501 and shaft 544 portions may be rougher than the head portion 530, saving time and money during manufacturing. Or, for example, there may be a sharper radius on the edges of the handle 501 and a flat portion 531 of the head 530 furthest from the shaft 544. Again, many variations of shapes, contours, and sizes of components are possible.

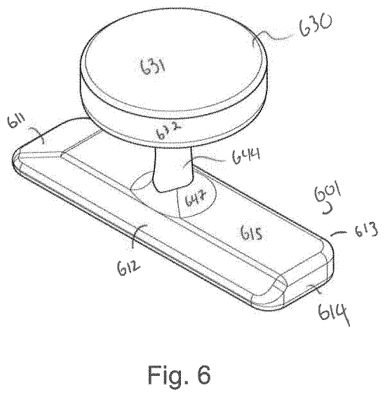

FIG. 6 depicts and additional embodiment where the handle 601, shaft 644, and head portions 630 have been combined to form a completed tool. As depicted, the handle 601 and head portions 630 are attached to opposite distal ends of the central shaft portion 644. The depicted example suggests that the attachment means is brazing, GTAW, or TIG welding 647. As discussed above and below, this is simply one example of many types of attachment means, and is not limiting. The depicted embodiment may be, for example, stainless steel and attached via TIG welding. Other welding processes are possible. FIG. 6 also provides a view of the long heavily chamfered and radius edge 612 of the handle 601 as well as the continuous radius edge furthest from the shaft 611. The head and handle portions may be polished in order to achieve a high level of reflectivity. The mirror like surface is smooth, such that it will not catch on the patient's skin. Other portions of the tool, such as the handle, may optionally not be polished in the same way. This may save time and money during manufacturing.

The various complete embodiments depicted, e.g. FIGS. 5A-D and 6, can optionally be constructed from various alternative materials and using alternative shapes. For example, the head portion can include a raised conical area for accepting the shaft. The shaft itself can lack a taper, and can flare toward the portion closest to the handle. Further, the head can be relatively narrow. Embodiments of the present invention may also be constructed from glass, which demonstrates the diversity of materials available for construction of the present invention, for example plastic, metal, or natural materials may also have be used. Further, the portion of the head furthest from the shaft is flat, whereas in other embodiments it may be conical or rounded. Or, one or more sides of the handle may be beveled. Additionally, the shaft may include one or more flared portions at the point of attachment to the handle and the head respectively. As depicted, the edges of the rectangular handle are different. For example, the “back” edge is depicted as flat, whereas the front includes multiple beveled portions.

Various embodiments of the present invention may be constructed using alternative means, such as 3D printing. This may allow for different shapes. For example, a flared shaft portion closest to the handle, a thicker head portion, as compared to FIG. 5D. Further, threads may be printed into the part, and the head and the shaft may be removably affixed using threads, the shaft and handle composed of a single piece, with the shaft including male threads at the distal end opposite the handle. These threads engage with corresponding female threads disposed in the head.

As discussed, one benefit of the tool is its size and weight. In a preferred embodiment, a completed tool according to an embodiment of the present invention, for example as depicted in FIGS. 5-6, can weigh from 12-18 ounces. In various other embodiments, the tool may weigh 10-50 ounces. Further, depending on the material, weights or slugs may be added to a completed tool, for example, in the center, in order to increase its weight. In other embodiments, the tool may have hollow sections, or may be solid. For example, the shaft portion may be capable of accepting weights.

While the preferred embodiment of the invention has been illustrated and described, as noted above, many changes can be made without departing from the spirit and scope of the invention. For example, therapist users may be any person who desires to use the device, and patient may be any person or animal who receives treatment by someone, including themselves, using the device. Further, therapeutic uses for this device exist beyond the industries described herein. Accordingly, the scope of the invention is not limited by the disclosure of the preferred embodiment. Instead, the invention should be determined entirely by reference to the claims that follow.

1. A physical therapy tool comprising:
A handle portion, wherein the handle portion further comprises;
Four edges, the four edges forming the perimeter of the handle portion and the perimeter being generally rectangular in shape such that a first and second edges are longer and a third and fourth edges are shorter than the first and second edges and wherein at least one of the third and fourth edges is beveled,
A shaft portion having two distal ends, the first distal end coupled to the handle portion; and
A head portion, the head portion coupled to the second distal end of the shaft portion.

2. The physical therapy tool of claim 1 further wherein the head portion is circular in shape.

3. The physical therapy tool of claim 1 further wherein the head portion opposite the side coupled to the shaft portion, is convex.

4. The physical therapy tool of claim 1 wherein the tool weighs between 12-18 ounces.

5. The physical therapy tool of claim 1 wherein the first and second edges of the handle portion are between about 3-5 inches long.

6. The physical therapy tool of claim 5 wherein the third and fourth edges of the handle portion are between about 0.75-2 inches long.

7. The physical therapy tool of claim 5 wherein the shaft portion is between about 1.5-3 inches long.

8. The physical therapy tool of claim 3 wherein the edges of the rounded head portion comprise a routed edge.

9. The physical therapy tool of claim 1 wherein one of the third and fourth edges is beleved.

10. A compact multi-use single hand physical therapy tool comprising;
A handle portion, wherein the handle portion further comprises;
a generally rectangular shape and wherein at least two of the edges are configured to deliver scraping based techniques and are beveled along their length;
A shaft portion having two distal ends, the first distal end coupled to the handle portion; and
A circular head portion, the head portion coupled to the second distal end of the shaft portion, the head portion configured to deliver a tempering technique.

11. The physical therapy tool of claim 10 wherein the tool weighs less than one pound.

12. The physical therapy tool of claim 11 wherein each of the handle portion, the shaft portion, and the head portion are constructed of stainless steel.

13. The physical therapy tool of claim 11 wherein the distance between the top of upper portion of the head, opposite the shaft, and the bottom of the handle, opposite the shaft, is between about 2-4 inches.
